(19) United States
(12) Patent Application Publication
(10) Pub. No.: US 2015/0304164 A1
(43) Pub. Date: Oct. 22, 2015

(54) Data center auto provisioning

(71) Applicant: Accton Technology Corporation, Hsin-Chu City (TW)

(72) Inventor: Arne Goetje, Hsin-Chu City (TW)

(73) Assignee: Accton Technology Corporation, Hsin-Chu City (TW)

(21) Appl. No.: 14/254,901

(22) Filed: Apr. 17, 2014

(51) Int. Cl. H04L 12/24

(52) U.S. Cl. CPC H04L 41/0806; H04L 41/0886; H04L 41/12

(57) ABSTRACT

A method and system for auto provisioning a data center network having a plurality of switches interconnected in a folded Clos topology includes each switch advertising information about itself to neighboring switches and locally storing received information. The configuration server queries information stored by one switch and uses a predefined protocol and the information stored by the one switch to query each switch neighboring the one switch about the information stored locally by the each switch neighboring the one switch to generate a database having topology information of the data center network. Configuration settings for each switch in the data center network are generated, with each generated configuration setting corresponding to one switch. The configuration server uses the predefined protocol and the database having topology information of the data center network to send the configuration settings to the corresponding one switch for each switch in the data center network.

### BACKGROUND OF THE INVENTION

1. Field of the Invention

This application relates to data center provisioning, and more specifically to an intelligent auto provisioning system for a data center, which auto detects the network topology and configures the switches accordingly while keeping manual intervention to a minimum.

2. Description of the Prior Art

An example of a folded Clos topology 100 is shown in FIG. 1. As can be seen, the folded Clos topology 100 may have a plurality of layers of switches, with each switch represented by a round-cornered rectangle and connections between ports of the switches are shown by lines connecting the respective round-cornered rectangles. Switches in the first layer, indicated by switch 120, each connect to a plurality of switches in the second layer, indicated by switch 130, which in turn each connects to a plurality of Top-of-Rack (ToR) switches (also known as a leaf switch) indicated by switch 140. The illustrated folded Clos topology 100 includes two virtual chassises VC1, VC2, and one of the ToR switches 110 is available for access by the configuration server (not shown).

Data centers may have multi-thousand to multi-ten thousand switches, interconnected in folded Clos topologies. Since manual provisioning of such a huge amount of devices would be very cumbersome, we need an intelligent auto-provisioning system, which auto detects the network topology and configures the switches accordingly. Manual intervention should be kept to a minimum.

Existing solutions rely on DHCP to auto assign IP addresses and push individual configuration files from a server to the switches. The configuration files need to be pre-generated, which causes additional burden to the network administrators. Also, the switches would need to be identified by their media access control (MAC) address, which means that the network administrators would need to either get a list of MAC addresses from the vendors, or type all MAC addresses into a database, in order to know where each switch is located in the data center and which configuration file to push to which switch.

### SUMMARY OF THE INVENTION

A method and system for auto provisioning a data center network having a plurality of switches interconnected in a folded Clos topology is disclosed. The method comprises each switch advertising information about itself to neighboring switches and locally storing information received from the neighboring switches and on which physical port the information was received. A configuration server directly connected to the data center network queries one switch neighboring the configuration server running about the information stored locally by the one switch and uses a predefined protocol and the information stored locally by the one switch to query each switch neighboring the one switch about the information stored locally by the each switch neighboring the one switch to generate a database having topology information of the data center network. The predefined protocol may utilize Ethernet frames and a specific EtherType ID. Configuration settings for each switch in the data center network are generated, with each generated configuration setting corresponding to one switch. The configuration server uses the predefined protocol and the database having topology information of the data center network to send the configuration settings to the corresponding one switch for each switch in the data center network.

The method may further comprise each switch advertising information about itself to neighboring switches using Link Layer Discovery Protocol (LLDP) by sending LLDP packets to the 01-80-C2-00-00-0E multicast media access control (MAC) address and when neighboring switches are connected through multiple parallel links, the neighboring switches receive as many LLDP packets on those links as parallel links exist. The one configuration server may be configured for remote access, using the Hypertext Transfer Protocol (HTTP) or Hypertext Transfer Protocol Secure (HTTPS) protocol. The configuration server may provide a web interface to display discovered data center network topology and facilitate generation of the configuration settings. Each switch may validate received configuration settings for syntax errors or unsupported features and notify the configuration server in case of an error.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an example folded Clos topology for a data center.

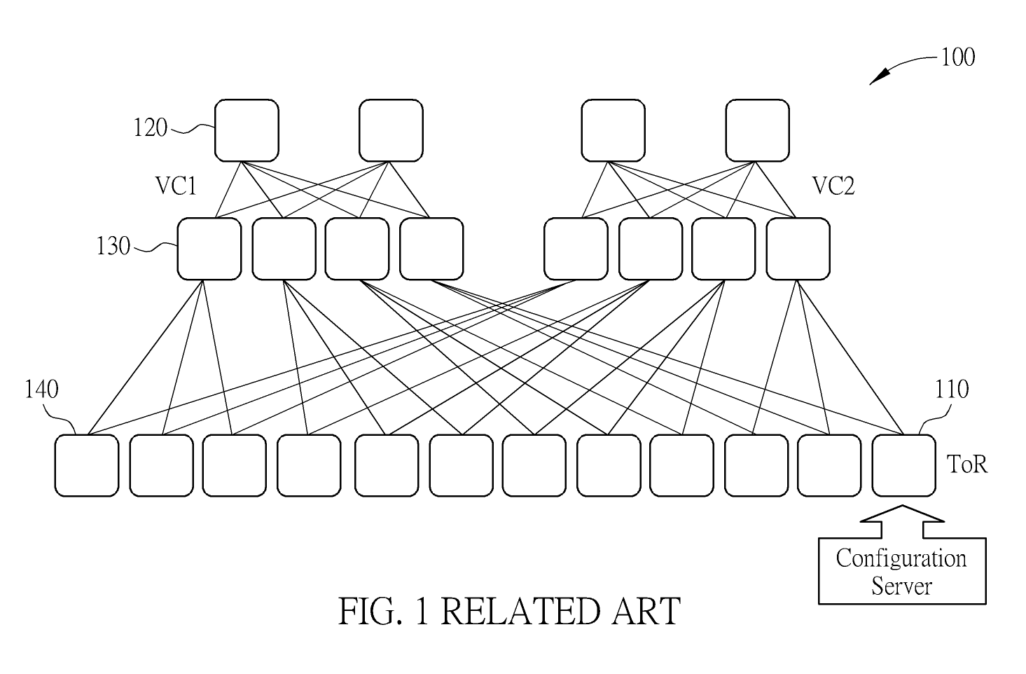

FIG. 2 illustrates another example folded Clos topology for a data center suitable for use with an intelligent auto provisioning system such as is proposed by embodiments of the invention.

FIG. 3 is a flow chart of handling a session identification (ID) while using an intelligent auto provisioning system such as is proposed by embodiments of the invention.

### DETAILED DESCRIPTION

To solve the problems encountered by the existing provisioning solutions as discussed above, an intelligent auto-provisioning system, which auto detects the network topology and configures the switches accordingly is proposed.

Prerequisites:

The switches are unconfigured, the spanning tree protocol is disabled on all ports, incoming packets get dropped by default, and MAC address learning is disabled. The switches are initially physically connected in a structure, which maps to the data center layout: e.g. a folded Clos topology, where port 1 of the leftmost leaf switch represents rack 1 in the data center. The to be configured network should not be connected to the existing network or downstream servers until the configuration has been finished and tested.

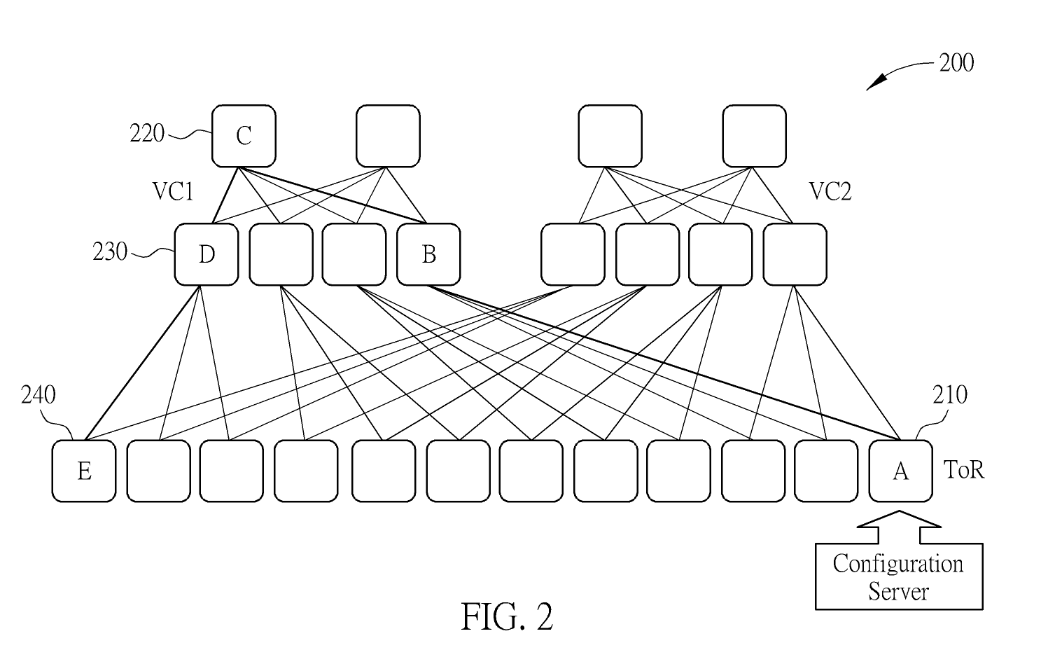

An example of a folded Clos topology 200 used in some embodiments is shown in FIG. 2. Somewhat similar to the folded Clos topology 100, the folded Clos topology 200 may have a plurality of layers of switches, with each switch again represented by a round-cornered rectangle and connections between ports of the switches are shown by lines connecting the respective round-cornered rectangles. Switches in the first layer, indicated by switch 220, each connect to a plurality of switches in the second layer, indicated by switch 230, which in turn each connects to a plurality of Top-of-Rack (ToR) switches (also known as leaf switches) indicated by switch 140. The example folded Clos topology 200 also includes two virtual chassises VC1, VC2, and one of the ToR switches 210 is available for access by the configuration server (not shown).

Theory of Operations:

Five steps are needed to auto-provision the whole network:
1. Individual switch topology learning
2. Aggregating the learned topologies into the configuration server
3. Display the aggregated learned topology to the administrator for confirmation
4. Setting the configuration options
5. Sending the configuration to the switches

Step 1: Individual Switch Topology Learning

Purpose: Individual switches learn about their directly attached neighbors.

The switches use the Link Layer Discovery Protocol (LLDP) (IEEE802.1AB) protocol to advertise themselves to the nearest neighbor, by sending LLDP packets to the 01-80-C2-00-00-0E multicast MAC address.

Neighboring switches receive, parse and store the advertised data into a local database in memory. LLDP packets are sent every 60 seconds, thus when a neighboring information has not been received for the timeframe specified by the “Time to Live” (TTL) value in the packet, the information should be dropped from the database. Data is received on each individual physical port; the receiving switch memorizes the port on which each neighboring information has been received. When a neighbor is connected through multiple parallel links (e.g. a Link Aggregation Group (LAG) is supposed to be formed), the switch will receive as many LLDP packets on those links as parallel links exist.

For example, when switch A connects to switch B with four parallel links, switch B will receive switch A's LLDP packets on all four ports, as well as sending its own LLDP packets out through the same four ports. Both switches will therefore be aware that they are connected through four parallel direct links.

The following type, length, and value triplets (TLVs) may be sent in the LLDP packets:
TLV Type 1 (Chassis ID—Mandatory), Subtype 3 (MAC address)=System MAC address
TLV Type 2 (Port ID—Mandatory), Subtype 5 (Interface Name)=ifName value of the Simple Network Management Protocol (SNMP) management information database (MIB)
TLV Type 3 (TTL—Mandatory)=180 seconds
TLV Type 8 (Management Address):
   Management Address Subtype=6 (a11802)
   Management address=System MAC address
   Interface Numbering subtype=2 (if Index)
   Interface Number=value of ifIndex

Step 2: Aggregating the Learned Topologies into the Configuration Server

Purpose: the central configuration server knows the whole network topology of the to be configured network.

The configuration server can run on any switch in the to be configured network, or on a separate device, which is directly connected to the to be configured network. In order for this to work, a single switch or device needs to be manually configured for remote access, using the Hypertext Transfer Protocol (HTTP) or Hypertext Transfer Protocol Secure (HTTPS) protocol, and enable the configuration server.

Since the configuration server is directly connected to the to be configured network, it will receive the LLDP packets from the neighboring switches and build its own local database.

The configuration server will then query its neighbors about their locally stored topology information, using a yet to be standardized Ethernet based protocol, described later in this document.

Step 3: Display the Aggregated Learned Topology to the Administrator for Confirmation

Purpose: To let the network administrator confirm that all switches have been discovered

The configuration server may run a web server and provide a web interface to the administrator. The web interface may display the discovered topology and let the administrator examine if all links and switches have been discovered.

In case some links and switches have not been discovered, the web interface may provide a simple interface to display the port status of the last discovered upstream switch, and in case port grouping (40G/10G) is used in the physical topology, to switch the port group mode on selected interfaces, as well as to re-query the switch.

The discovered topology may be exported into comma-separated values (CSV), Extensible Markup Language (XML), or other formats, in order to easily import the data into existing Network Management Systems.

Step 4: Setting the Configuration Options

The web interface can also be used to let the administrator configure some basic settings on the switches with the help of pre-designed templates.

| Category | Settings |
|---|---|
| Security | Passwords, Authentication options, SSH keys |
| Management | Addressing scheme, Hostname, SNMP, Remote |
| | management |
| Network | Topology: MPLS, OSPF, BGP, OSPF + BGP, OpenFlow, |
| | LAGs, ECMP |
| Others | . . . |

Step 5: Sending the Configuration to the Switches

The configuration options may be sent to the switches using the communication protocol as described later. The configuration may not take effect until all configuration options have been sent and a corresponding command has been sent to the switch. The administrator may examine the installed configuration before finally applying it. The switches may validate the submitted configuration for syntax errors or unsupported features and notify the configuration server by sending error messages.

An Example Yet to be Standardized Communication Protocol

Since Layer 3 address configuration and network segmentation has not taken place yet, traditional networking behavior must be kept in mind in order to understand the need for this protocol.

Traditionally, switches will broadcast their MAC address to all devices in the networking domain. With large datacenters and multi-10k switches, this is easy to overflow the MAC Forwarding tables on the switches. Assigning IP addresses, even with IPv6, via DHCP would not solve this problem, since they would also need to be in the same subnet without configured routers in place.

Therefore a new communication protocol just for this purpose is proposed. The protocol will use Ethernet frames and a yet to be assigned EtherType ID. Frame sizes can be standard MTU (1500 bytes) or Jumbo frames (9k bytes), depending on the network size and the number of next hops between the configuration server and the furthest switch. Broadcasting must be disabled.

The proposed Ethernet frame can comprises the following fields, preferably in the following order.

| | |
|---|---|
| Preamble | 8 Bytes |
| Destination MAC | 6 Bytes |
| Source MAC | 6 Bytes |
| EtherType/Size | 2 Bytes |
| Payload | variable size, perhaps between |
| | 46 and 1500 Bytes |
| CRC Checksum | 4 Bytes |

The next table identifies the keys used in the following description of use of the proposed Ethernet frame for auto-provisioning a folded Clos topology having the stated prerequisites.

| Key | Name | Length | Description |
|---|---|---|---|
| P | Preamble | 8 | Ethernet preamble |
| DMAC | Destination | 6 | Mac address of next hop |
| | Mac | | |
| SMAC | Source | 6 | Mac address of this host |
| | MAC | | |
| ET | EtherType | 2 | Yet to be assigned by IEEE |
| PL | Path Length | 2 | Number of hops in between sender and receiver |
| HMACn | Hop MAC | 6 | Mac address of intermediate hop |
| RMAC | Receiver | 6 | Last Hop MAC address (Receiver) |
| | MAC | | |
| RPL | Return Path | 2 | Same as Path Length, but for the return path |
| | Length | | |
| SID | Session ID | 4 | Session ID to be assigned by the sender |
| MT | Message | 1 | A defined Message Type (see below) |
| | Type | | |
| MST | Message | 1 | A defined Message Sub Type (see below), depending on |
| | Sub Type | | the Message Type. |
| SQN | Sequence | 2 | Packet (frame) sequence number within a session, |
| | Number | | starting at 1 |
| DSL | Data Stream | 2 | Number of fragments sent for the following data stream, |
| | Length | | depending on the actual length of the data to be sent and |
| | | | the frame size (MTU). If the data exceeds the MTU, the |
| | | | data is split up into multiple fragments. This number |
| | | | indicates the total number of fragments needed to |
| | | | reassemble the data. |
| DATA | Data Stream | Variable | Actual data in a higher level protocol (e.g. JSON, XML, etc.) |
| CRC | Checksum | 4 | Ethernet Frame Checksum |

Format:
[P] [DMAC] [SMAC] [ET] [PL] [HMACn|RMAC] [RPL] [HMACn|RMAC] [SID] [MT] [MST] [SQN] [DSL] [DATA] [CRC]

When the packet traverses the path towards its final destination, the next hop and return hops are adjusted on the way, together with the frame's source and destination address.

### EXAMPLE

The configuration server sends a request to a switch, which is 4 hops away. Since the configuration server knows the whole topology, it picks one of the shortest paths available and populates the Ethernet frame as follows:
[P] [DMAC=nexthop] [SMAC=localMac] [ET] [PL=3] [RMAC=final_destination] [HMAC2=final_destination−1] [HMAC1=nexthop+1] [RPL=0] [SID] [MT] [S QN] [DSL] [Data] [CRC]

When passed to the next hop, the next hop will take the packet apart, appends SMAC to the Return Path and increments the Return Path Length counter, pops off the next hop+1 from the Path list and decrements the Path hop counter by one, puts the nexthop+1 MAC into the DMAC field and its own MAC into the SMAC field, and send it out to the nexthop+1.

For example refer to FIG. 2. The following Ethernet frames can be used to send a packet from A to E:

Switch A transmits:
[P] [DMAC:B] [SMAC:A] [ET] [PL:3] [E] [D] [C] [RPL:0] [SID] [MT] [SQN] [DSL] [Data] [CRC]

Switch B receives the packet transmitted from switch A, changes the destination of the packet to be “C” ([DMAC:C]), changes the source of the packet to be “B” ([SMAC:B]), changes the path length to be “2” ([PL:2]), removes “C” ([C]) from the path, increments the return path length (RPL:1), adds the source of the current packet ([A]) to the return path, and transmits the following command to switch C.
[P] [DMAC:C] [SMAC:B] [ET] [PL:2] [E] [D] [RPL:1] [A] [SID] [MT] [SQN] [DSL] [Data] [CRC]

Switch C receives the packet transmitted from switch B, changes the destination of the packet to be “D” ([DMAC:D]), changes the source of the packet to be “C” ([SMAC:C]), changes the path length to be “1” ([PL:1]), removes “D” ([D]) from the path, increments the return path length (RPL:2), adds the source of the current packet ([B]) to the return path, and transmits the following command to switch D.
[P] [DMAC:D] [SMAC:C] [ET] [PL:1] [E] [RPL:2] [A] [B] [SID] [MT] [SQN] [DSL] [Data] [CRC]

Switch D receives the packet transmitted from switch C, changes the destination of the packet to be “E” ([DMAC:E]), changes the source of the packet to be “D” ([SMAC:D]), changes the path length to be “0” ([PL:0]), removes “E” ([E]) from the path, increments the return path length (RPL:3), adds the source of the current packet ([C]) to the return path, and transmits the following command to switch E.
[P] [DMAC:E] [SMAC:D] [ET] [PL:0] [RPL:3] [A] [B] [C] [SID] [MT] [SQN] [DSL] [Data] [CRC]

Switch E processes the data and sends the response back to A, copying the return path into the sending path and transmits the following packet to switch D:
[P] [DMAC:D] [SMAC:E] [ET] [PL:3] [A] [B] [C] [RPL:0] [SID] [MT] [SQN] [DSL] [Data] [CRC]

Switch D receives the packet transmitted from switch E, changes the destination of the packet to be “C” ([DMAC:C]), changes the source of the packet to be “D” ([SMAC:D]), decrements the path length to be “2” ([PL:2]), removes “C” ([C]) from the path, increments the return path length ([RPL:1]), adds the source of the current packet ([E]) to the return path, and transmits the following command to switch C.
[P] [DMAC:C] [SMAC:D] [ET] [PL:2] [A] [B] [RPL:1] [E] [SID] [MT] [SQN] [DSL] [Data] [CRC]

Switch C receives the packet transmitted from switch D, changes the destination of the packet to be “B” ([DMAC:B]), changes the source of the packet to be “C” ([SMAC:C]), decrements the path length to be “1” ([PL:1]), removes “B” ([B]) from the path, increments the return path length ([RPL:2]), adds the source of the current packet ([D]) to the return path, and transmits the following command to switch B.

[P] [DMAC:B] [SMAC:C] [ET] [PL:1] [A] [RPL:2] [E] [D] [SID] [MT] [SQN] [DSL] [Data] [CRC]

Switch B receives the packet transmitted from switch C, changes the destination of the packet to be “A” ([DMAC:A]), changes the source of the packet to be “B” ([SMAC:B]), decrements the path length to be “0” ([PL:0]), removes “A” ([A]) from the path, increments the return path length ([RPL:3]), adds the source of the current packet ([C]) to the return path, and transmits the following command to switch A.
[P] [DMAC:A] [SMAC:B] [ET] [PL:0] [RPL:3] [E] [D] [C] [SID] [MT] [SQN] [DSL] [Data] [CRC]

Switch A receives and processes data in the packet.

Session ID:

Since the sessions are only initiated by the configuration server, the server manages all Session IDs.

Session Message Types:

| | | Data | |
|---|---|---|---|
| Type | Message | Length | Data Value |
| 0x00 | Session Init | 0 | None |
| 0x01 | ACK | 0 | None |
| 0x02 | Get Request | Variable | Command |
| 0x03 | Get Reply | Variable | Data |
| 0x04 | Set Request | Variable | Command, Data |
| 0x05 | Retransmit | Variable | [length][sequence_number][sequence_number] . . . |
| | request | | |
| 0x06 | Retransmit | Variable | Data |
| | reply | | |
| 0x07-0x0E | <Reserved> | | |
| 0x0F | Session End | 0 | None |

Session Init (0x00): Sent by the configuration server to the switch to initialize a session with the supplied session ID. If the session is already open, the session gets reset. The recipient switch replies with an ACK (0x01) and clears all buffers for this session, if any exist.

Get Request (0x02): Sent by the configuration server, contains a command and optionally data payload

| Sub Type | Message | Length | Value |
|---|---|---|---|
| 0x00 | Get System Information | 0 | None |
| 0x01 | Get Port status | 0 | None |
| 0x02 | Get Port status update | 0 | None |
| 0x03 | Get Debug Information | 0 | None |
| 0x04-0x0F | <Reserved> | | |
| 0x10-0xFF | <User defined> | Variable | Variable |

Get Reply (0x03): Sent by the switch, contains the requested data or error code. The data format follows a higher level protocol, which is outside the scope of this document (e.g. JSON, XML, etc.)

| Sub Type | Message | Length | Value |
|---|---|---|---|
| 0 | Data | Variable | Data |
| 1 | Error | Variable | Error code(s) (TBD) |

Set Request (0x04): Sent by the configuration server in order to push configuration settings to the switch. The data format follows a higher level protocol, which is outside the scope of this document (e.g. JSON, XML, etc.)

Retransmit Request (0x05): In case the recipient notices, that packet fragments are missing (sequence number is missing), it can request a retransmission of that specific sequence number, or multiple sequence numbers. The data fields are:
[length]=number of requested sequence numbers [2 octets]
[sequence numbers]=list of missing sequence numbers in the current session [2 octets each]

Retransmit Reply (0x06): Same as Get Reply, with the corresponding sequence numbers set. The sequence number does not get incremented.

Session End (0x0F): Closes the active session and releases all associated buffers. Is only sent by the configuration server and acknowledged by the switch with an ACK (0x01) packet.

Session Buffering:

The switch buffers all packets within a session, in order to be able to resend lost packets.

SequenceNumber (SQN) and DataStreamLength (DSL):

Packets (frames) sent within a session carry a sequence number and the data stream length. The sequence number increments with each packet sent within a session, the DataStreamLength indicates that the to be sent data stream consists of n packets (fragments). In case of Retransmit Replies, the sequence number does not get incremented and the original frame with the original sequence number resent instead.

Session Timeouts:

In case a packet has been sent and no ACK received after a specified (TBD) Timeout, the packet should be resent. To prevent infinite looping, a maximum retransmit number could be set.

Session Port Status and Port Status Update:

After the switch has successfully sent the port status information for the first time, it keeps track when it has answered this request by means of keeping the timestamp of the last request in memory. The server, after successfully receiving the initial port status information from that switch, will send subsequent Port Status Update requests periodically. The switch will then only supply the changes after the last query. If the server loses its memory (i.e. by reboot or re-initialization), it queries the initial Port Status information again. If the switch loses its memory (i.e. by reboot), it will send the complete port status information, even only the Port Status Updates have been requested.

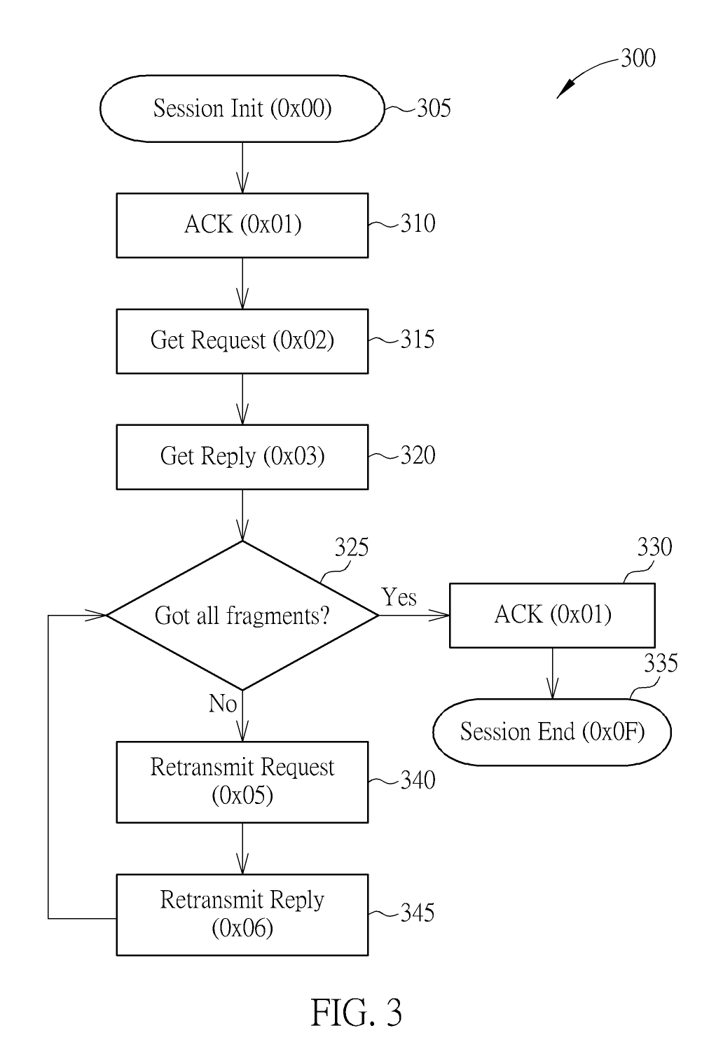

FIG. 3 is a flow chart of handling a session ID while using an intelligent auto provisioning system such as is proposed by embodiments of the invention. In step 305, the session init is transmitted. An acknowledgement (ACK) is received in step 310. Once the session is established, a Get Request (step 315) is issued, followed by a Get Reply (step 320), leading to the decision box determining if all fragments of requested data have been received (step 325). If all of the fragments of the requested data have been received, an ACK (step 330) is sent and the session ends (step 335). If all of the fragments of the requested data have not been received in step 325, the request is retransmitted (step 340) and a reply is retransmitted (step 345) where again a determination of whether all fragments of the requested data have been received is made in step 325.

In summary a method of auto provisioning a data center that may have multi-thousand to multi-ten thousand switches which may be interconnected in a folded Clos topology is proposed. Each switch uses LLDP protocol to advertise themselves to the nearest neighbor, by sending LLDP packets to the 01-80-C2-00-00-0E multicast MAC address. Neighboring switches receive, parse and store the advertised data and on which port the advertised data was received into a local database in memory. A configuration server directly connected to the to be configured network, receives the LLDP packets from the neighboring switches and builds its own local database. The configuration server then queries its neighbors about their locally stored topology information creating a database having stored topology information of the entire network. A web interface displays the discovered topology and lets the administrator examine if all links and switches have been discovered. Configuration options for each switch can be set and sent to the switches using a communication protocol previously described according to the database having stored topology information of the entire network.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for auto provisioning a data center network having a plurality of switches interconnected in a folded Clos topology, the method comprising:
each switch advertising information about itself to neighboring switches and locally storing information received from the neighboring switches and on which physical port the information was received;
a configuration server directly connected to the data center network querying one switch neighboring the configuration server about the information stored locally by the one switch;
the configuration server using a predefined protocol and the information stored locally by the one switch querying each switch neighboring the one switch about the information stored locally by the each switch neighboring the one switch to generate a database having topology information of the data center network;
generating configuration settings for each switch in the data center network, each generated configuration setting corresponding to one switch; and
the configuration server using the predefined protocol and the database having topology information of the data center network to send the configuration settings to the corresponding one switch for each switch in the data center network.

2. The method of claim 1 further comprising each switch advertising information about itself to neighboring switches using Link Layer Discovery Protocol (LLDP) by sending LLDP packets to the 01-80-C2-00-00-0E multicast media access control (MAC) address.

3. The method of claim 2 wherein when neighboring switches are connected through multiple parallel links, the neighboring switches receive as many LLDP packets on the multiple parallel links as parallel links exist.

4. The method of claim 1 further comprising configuring the configuration server to provide a web interface displaying discovered data center network topology.

5. The method of claim 4 further comprising using the web interface to generate the configuration settings.

6. The method of claim 5 further comprising utilizing predesigned templates to set the configuration settings.

7. The method of claim 1 further comprising each switch validating received configuration settings for syntax errors or unsupported features and notifying the configuration server in case of an error.

8. The method of claim 1 wherein the predefined protocol uses Ethernet frames and a specific EtherType ID.

9. A system for auto provisioning a data center network, comprising:
a plurality of unconfigured switches physically interconnected in a folded Clos topology, each switch advertising information about itself to neighboring switches and locally storing information received from the neighboring switches and on which physical port the information was received; and
a configuration server directly connected to the data center network, the configuration server querying one switch neighboring the configuration server about the information stored locally by the one switch,
wherein the configuration server uses a predefined protocol and the information stored locally by the one switch querying each switch neighboring the one switch about the information stored locally by the each switch neighboring the one switch to generate a database having topology information of the data center network, and the configuration server generates configuration settings for each switch in the data center network, each generated configuration setting corresponding to one switch; and
the configuration server uses the predefined protocol and the database having topology information of the data center network to send the configuration settings to the corresponding one switch for each switch in the data center network.

10. The system of claim 9, wherein each switch advertises information about itself to neighboring switches using Link Layer Discovery Protocol (LLDP) by sending LLDP packets to the 01-80-C2-00-00-0E multicast media access control (MAC) address.

11. The system of claim 9 further comprising:
a web interface provided by the configuration server to display discovered data center network topology.

12. The system of claim 9, wherein each switch validates received configuration settings for syntax errors or unsupported features and notifies the configuration server in case of an error.
